(19) United States
(12) Patent Application Publication
(10) Pub. No.: US 2016/0359447 A1
(43) Pub. Date: Dec. 8, 2016

(54) PHOTOVOLTAIC MODULE

(71) Applicant: SOLARWORLD AG, Bonn (DE)

(72) Inventors: Markus HUND, Euskirchen (DE); Holger NEUHAUS, Freiberg (DE); Harald HAHN, Dresden (DE); Sven WENDT, Dresden (DE)

(73) Assignee: SOLARWORLD AG, Bonn (DE)

(21) Appl. No.: 15/143,975

(22) Filed: May 2, 2016

(30) Foreign Application Priority Data
Jun. 8, 2015 (DE) 20 2015 102 947.0

(51) Int. Cl. H02S 40/22; H02S 40/30; H02S 40/32; H02S 30/10

(52) U.S. Cl. CPC H02S 40/22; H02S 30/10; H02S 40/30; H02S 40/32

(57) ABSTRACT

Photovoltaic module including a module laminate with several electrically interconnected partially or completely bifacial photovoltaic cells, which are embedded in an encapsulation material, wherein photovoltaic cells are adjacently disposed such that there is a cell gap between two respective mutually adjoining photovoltaic cells, wherein module laminate includes a front and rear-side surfaces which are opposite front-side surface; module frame, which encircles module laminate; module rear-wall disposed at distance from rear-side surface of module laminate and fixed on module frame, which covers at least one portion of rear-side surface of module laminate; wherein at least one portion of module rear-wall which is facing rear-side surface of module laminate, forms a diffuse backside reflector; wherein diffuse backside reflector is disposed such that at least one portion of light which penetrates through at least one cell gap of several cell gaps, is reflected on rear-side surface of module laminate.

Normally, a photovoltaic module has a plurality of electrically interconnected photovoltaic cells. Normally, the photovoltaic cells are adjacently disposed at a distance from each other within a photovoltaic module, so that a cell gap, which is generally filled with an encapsulation material, is formed between two respective mutually adjoining photovoltaic cells.

The light penetrating through the cell gaps, therefore which does riot strike the light incident side of the photovoltaic cells, significantly contributes to the reduction of power of a photovoltaic module.

For this reason, various developments were carried out in order to make this light useful. So, currently it is possible to increase the power generation in a photovoltaic module by capturing light in the cell gaps In a present-day photovoltaic module, approximately 30% of the light striking in the cell gaps is again reflected back to the photovoltaic cells on the upper glass cover of the photovoltaic cells by means of total reflection. However, the light scattered behind the photovoltaic cells gets lost and is absorbed in the backside metallizations.

By using a white encapsulation (e.g. EVA: Ethylene Vinyl Acetate), it is attempted to deal with this problem. However, using such an encapsulation has the disadvantage that the normally used lamination process must be controlled such that no white encapsulation material surrounds the cell edge of a respective photovoltaic cell.

Normally, this is complex and expensive.

For example, a so-called bifacial solar cell is described in DE 10 2004 049160 B4.

According to different exemplary embodiments, the electrical output provided by the respective photovoltaic cell is increased by a simple modification in the manufacturing process and the rear-side structure photovoltaic cell.

A photovoltaic module is provided in different exemplary embodiments. The photovoltaic module can have a module laminate with several electrically interconnected, partially or completely bifacial photovoltaic cells, which are embedded in an encapsulation material. The several photovoltaic cells are adjacently disposed such that there is a cell gap between two respective mutually adjoining photovoltaic cells. The module laminate has a front-side surface and rear-side surface which is opposite the front-side surface. The photovoltaic module can further have a module frame, which encircles the module laminate, and the module rear-wall disposed at a distance from the rear-side surface of the module laminate and fixed on the module frame, which covers at least a portion of the rear-side surface of the module laminate. At least a portion of the module rear-wall which is facing the rear-side surface of the module laminate forms a diffuse rear-side reflector. The diffuse backside reflector is lisposed such that at least a portion of the light, which penetrates through at least one cell gap of the several cell gaps, is reflected on the rear-side surface of the module laminate.

In different exemplary embodiments, a module laminate can be a laminate of several layers, for example a laminate of the following components:
several photovoltaic cells substrates (also referred to as substrates in the following);
encapsulation material, in which the several photovoltaic cells substrates are embedded;
optionally a first cover plate (for example of glass) applied over the front-side of the photovoltaic cello substrates and/or a second cover plate (for example of glass) applied under the rear-side of the photovoltaic cells substrates.

The fact that the diffuse backside reflector is disposed at a distance from the rear-side surface of the module laminate, still more light which penetrates through the cell gaps is reflected on the rear-side surface of the module, laminate and based on the diffuse scattering on the rear-side surface of the respective photovoltaic cells, whereby the efficiency of the photovoltaic module is increased.

In one configuration, the module rear-wall can completely cover the rear-side surface of the module laminate. This configuration enables a very easy assembly of the photovoltaic module.

In still another configuration, the module rear wall can be spaced apart from the module frame and fixed on the module frame by means of spacer. Because of this, for example by means of the spacers, the assembly stability is further increased.

In yet another configuration, the diffuse backside reflector can have an albedo of at least 50%, for example at least 60%, for example at least 70%, for example at least 80%, for example at least 90%.

The surface of the diffuse backside reflector facing the module laminate can be white, whereby a very high reflectivity and a high albedo is easily achieved.

For increasing the albedo further, the surface of the diffuse backside reflector facing the module laminate have several layers. Thus or example, a first layer of the several layers facing tie module laminate can be transparent and a second layer of the several layers which is disposed on the side of the first layer turned away from the module laminate, can have an albedo of at least 50%, for example at least 60%, for example at least 70%, for example at least 80%, for example at least 90%. Furthermore, the first layer of the several layers facing the module laminate should have a smooth surface.

The second layer can white or can have a micro structured (diffuse scattering) metal film/or a micro structured (diffuse scattering) sheet etc. or can consist of the same.

In another configuration, at least a portion of the inner side of the module frame can have an albedo of at least 50%, for example at least 60%, for example at least 70%, for example at least 80%, for example at least 90%. Thus for example, at least a portion of the inner side of the module frame can be white. In this way, the efficiency of the photovoltaic modules can be increased further.

In another configuration, the module rear-wall can have at least one metal plate (for example minimum or another reflecting metal) and/or at least one plastic plate and/or at least one plastic film.

In another configuration, the photovoltaic module can further have at least one electronic component, which is disposed between the rear-side surface of the module laminate and the module rear-wall. The module rear-wall can hold the at least one electronic component on the rear-side surface of the module laminate. In this way, evidently, a force fitted or form fitted fixing of the at least one electronic component is achieved by means of the module rear-wall. This represents a very cost-effective and compact option for holding the at least one electronic component in the photovoltaic module.

The at least one electronic component can have a DC converter and/or a module inverter. The at least one electronic component can have the so-called bypass diodes. In such a case, the half-cell arrangement of such photovoltaic modules is substantially simplified, because the bypass diodes must not be introduced into the junction box any more, but can be disposed at any position in the laminate. This saves corresponding conductor for the case of bypass.

Furthermore, the module rear-wall can be in thermally conducting contact with the at least one electronic component.

In different exemplary embodiments, a photovoltaic module is provided. The photovoltaic module can have a module laminate with several electrically interconnected photovoltaic cells, which are embedded in an encapsulation material. The several photovoltaic cells are adjacently disposed such that there is a cell gap between two respective mutually adjoining photovoltaic cells. The module laminate has a front-side surface and a rear-side surface which is opposite the front-side surface. The photovoltaic module can further have a module frame, which encircles the module laminate, and a module rear-wall disposed at a distance from the rear-side surface of the module laminate and fixed on the module frame, which covers at least a portion of the rear-side surface of the module laminate. Furthermore, at least one electronic component can be provided in the photovoltaic module, which is disposed between the rear-side surface of the module laminate and the module rear-wall. The module rear-wall can hold the at least one electronic component.

The at least one electronic component can have a so-called DC converter and/or a module inverter. The at least one electronic component can have so-called bypass diodes. In such a case, the half-cell arrangement of such photovoltaic modules can be substantially simplified, because the bypass diodes must not be introduced in the junction box any more, but can be disposed at any position in the laminate. This saves c responding conductor for the case of bypass.

In another configuration, the module rear wall has at least one metal plate.

Furthermore, the module rear-wall can make an electrically conductive connection between the electrical component and the module frame.

In another configuration, the module rear-wall can have at least one through opening.

In another configuration, the module rear-wall can have at least one first area which extends substantially parallel to the rear-side surface of the module laminate, and at least one second area which does not extend parallel to the rear-side surface of the module laminate. The module rear-wall can have at least one through opening in the at least one second area.

The at least one through opening can be dimensioned and disposed in the module rear wall such that an air-circulation is enabled by means of convection.

Alternatively or additionally, the photovoltaic module can further have at least one blower, for example a cross-blower, which is disposed between the rear-side surface of the module laminate and the module rear-wall for producing a forced air-circulation.

Furthermore, at least one through opening can be provided in the module frame on each side, so that an air-circulation is enabled therethrough.

The module rear-wall can be in thermally conductive contact with the at least one electronic component.

The diffuse backside reflector (which is a characteristic of the module rear-wall) can be disposed at a distance of several cm, for example in a range of approximately 1 cm to approximately 10 cm, from the rear-side surface of the module laminate.

Furthermore, the gap width of at least one cell gap of the several cell as can be in a range of approximately 3 mm to approximately 50 mm.

In conventional photovoltaic modules, it was advantageous to lay the white reflector (e.g. of rear-side films or the white prints imprinted on the inner side of the rear-glass of glass-glass-photovoltaic cells modules or a rear-side white encapsulation) as close as possible to the photovoltaic cells rear-side, in order to scatter less light behind the photovoltaic cell. With bifacial photovoltaic cells according to different exemplary embodiments, it is now actually more advantageous to move the rear-reflector as far away from the photovoltaic cells rear-side as possible, so that the maximum light is scattered behind the solar cell. In a photovoltaic module according to different exemplary embodiments with relocated rear-side reflector, as will be explained in more details in the following, for example approximately 100% of the light can be directed from the cell gap towards the photovoltaic cells rear-side.

In another configuration, the diffuse backside reflector can be disposed over another further described rear-side transparent cover plate opposite the encapsulation at a distance. In another configuration, the diffuse backside reflector is disposed at a distance of several cm, for example in a range of approximately 1 cm to approximately 10 cm from the rear-side surface of the second transparent cover plate (i.e. for example the cover plate which is disposed under the rear-side surface of the substrate).

Exemplary embodiments of the invention are represented in the figures and are explained in more details in the following.

They show:

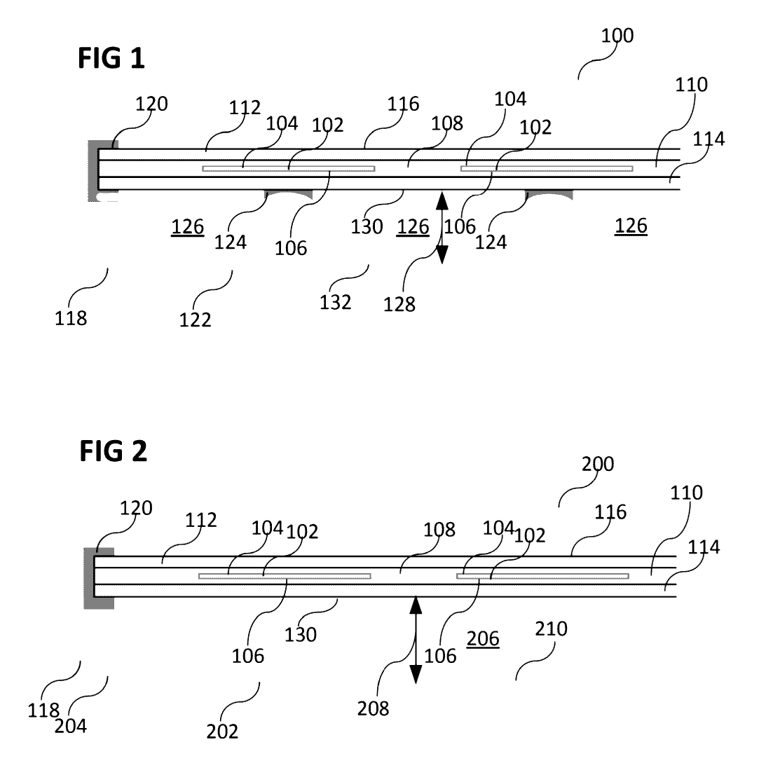

FIG. 1 shows a cross-sectional view of a portion of a solar cell module arrangement according different exemplary embodiments;

FIG. 2 shows a cross-sectional view of a portion of a solar cell module arrangement according to different exemplary embodiments;

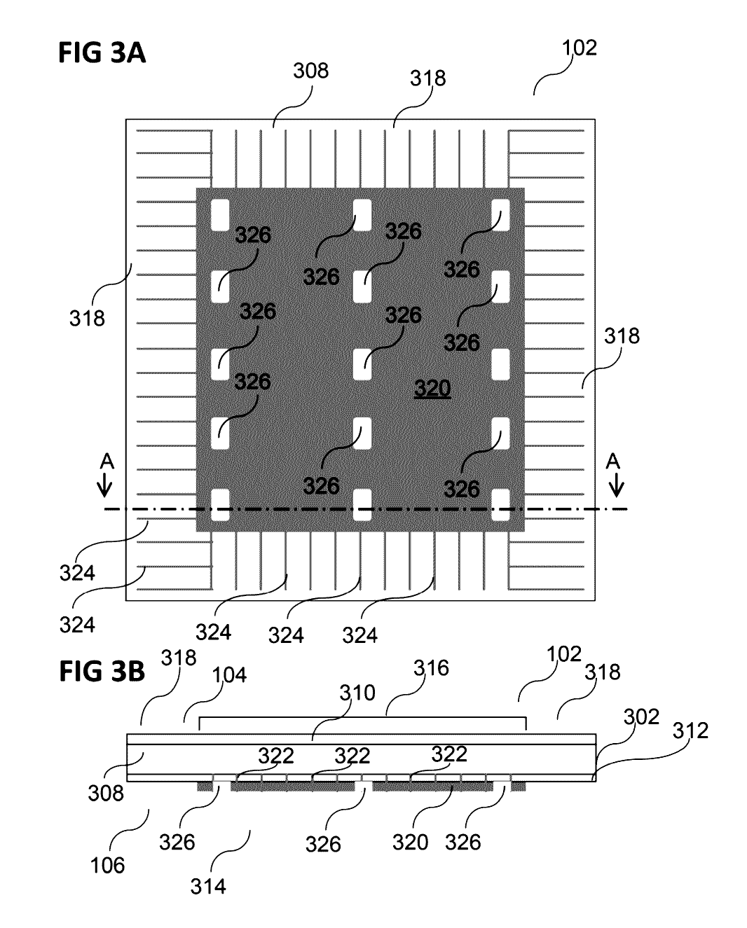

FIG. 3A shows a backside view of a solar cell according to different exemplary embodiments;

FIG. 3B shows a cross-sectional view of the solar cell from FIG. 3A;

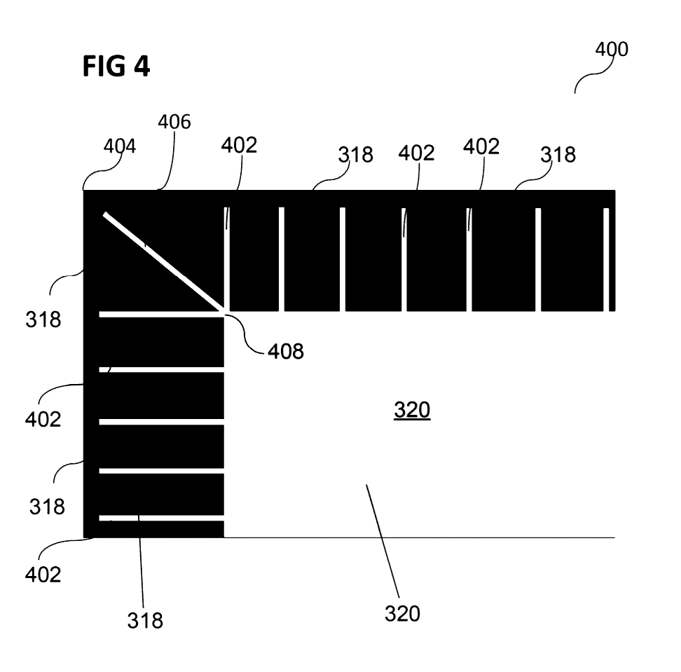

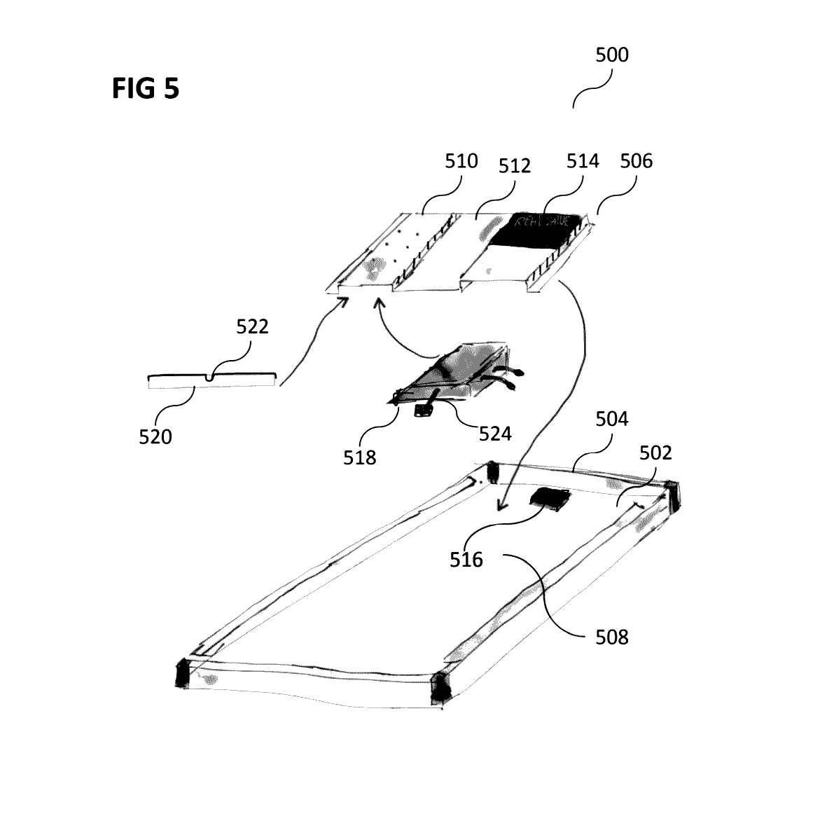

FIG. 4 shows an enlarged section of a backside view of a solar cell according to different exemplary embodiments;

FIG. 5 shows an exploded representation of a solar cell module according to different exemplary embodiments;

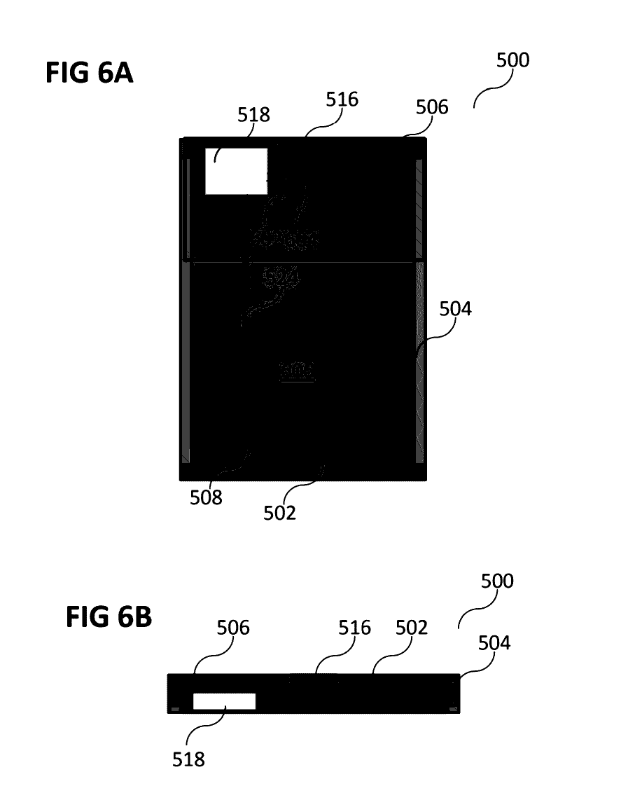

FIG. 6A shows a backside view of a solar cell module according to different exemplary embodiments;

FIG. 6B shows a sectional view of the solar cell module from FIG. 6A;

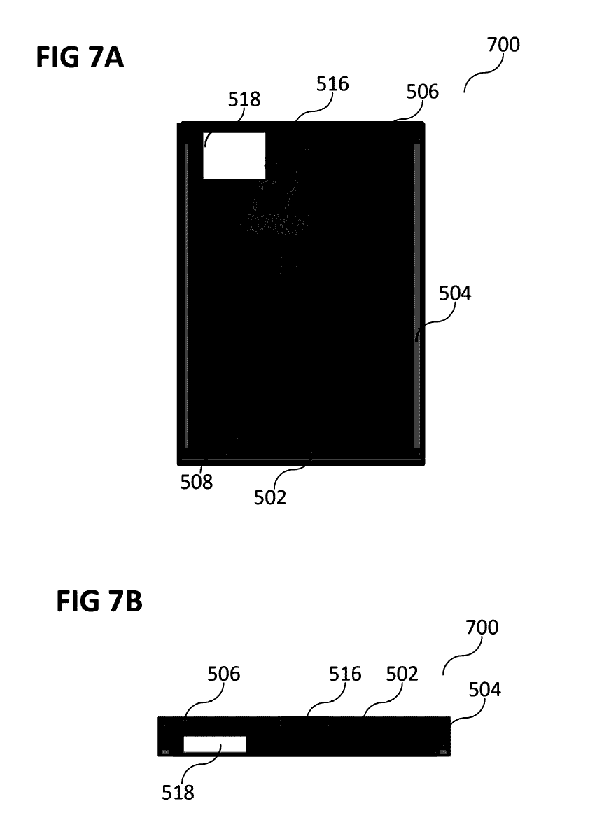

FIG. 7A shows a backside view of a solar cell module according to different exemplary embodiments;

FIG. 7B shows a sectional of the solar cell module from FIG. 7A;

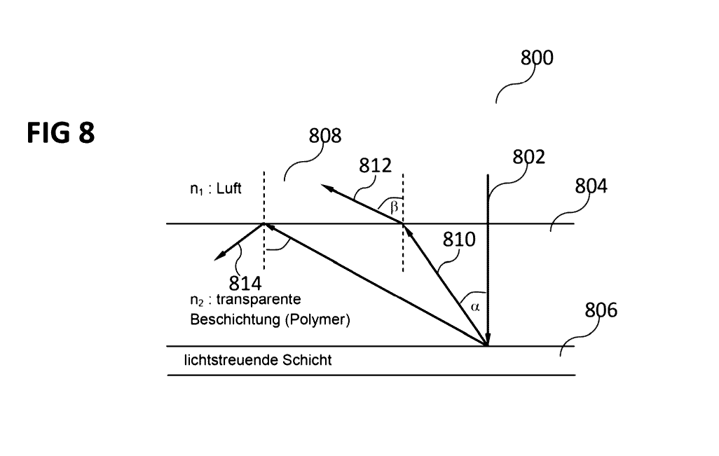

FIG. 8 shows a representation for explaining Snell' Law;

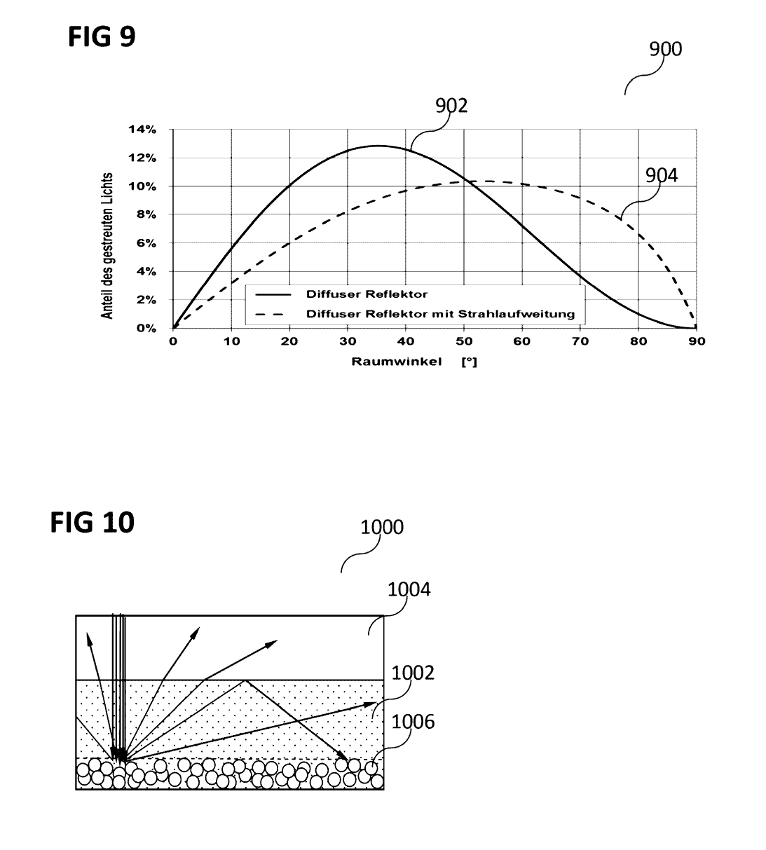

FIG. 9 shows a diagram, in which, a portion of the scattered light for a diffuse reflector and for a diffuse reflector with beam expansion is represented independent of a solid angle; and

FIG. 10 shows a cross-sectional view of a diffuse reflector in the form of a multi-layered stack of layers according to different exemplary embodiments.

In the following detailed description, reference is made to the accompanying drawings, which form the part of this and in which specific embodiments are shown for illustration, in which the invention can be exercised. In this regard, directional terminology such as “above”, “below”, “front”, “behind”, “forward/anterior”, “rearward/posterior”, etc. are used with reference to the orientation of the described figure(s). Since components of exemplary embodiments can be positioned in a number of different orientations, the directional terminology is used for illustration and is not limited in any way. It must be understood that other embodiments can be used and structural or logical modifications can be undertaken, without departing from the scope of protection of the present invention. It must be understood that the features of the different exemplary embodiments described herein can be combined with each other, unless specifically stated otherwise. Therefore, the following detailed description is not to be seen in a restrictive sense, and the scope of protection of the present invention is defined by the attached claims.

Within the scope of this description, the terms “joined”, “connected” and “coupled” used for describing a direct as well as an indirect connection, a direct or indirect joining and a direct or indirect coupling. In the figures, identical or similar elements are provided with identical reference numerals, wherever appropriate.

The physical values used herein, which relate to the optical characteristics, can for example be dependent on the wavelengths, so that these are provided as values averaged over the range of the wavelength of the visible light (for example 400 nm to 800 nm).

In different exemplary embodiments, a photovoltaic for example a solar cell comprises, a device, which converts the radiation energy of predominantly visible light and infrared light (for example at least a portion of the light into visible range of wavelengths of approximately 300 nm to approximately 800 nm; it should be noted that additionally even ultraviolet (UV) radiation and/or Infrared (IR) radiation up to about 1150 nm can be converted), for example of sunlight, directly into electrical energy by means of the so-called photovoltaic effect.

In different exemplary embodiments, a photovoltaic module, for example a solar module comprises, an electrically connected device with several photovoltaic cells, for example several solar cells (which are interconnected in series and/or in parallel), and optionally connected to a weather protection (for example glass), an embedding and a frame.

FIG. 1 shows a cross-sectional view of a portion of a solar cell module arrangement 100 according to different exemplary embodiments.

The solar cell module arrangement 100 as an example of a photovoltaic module arrangement has one or more solar cells (generally one or more photovoltaic cells) 102, wherein a section of an edge trim of one such solar cell module 100 is represented in FIG. 1.

The solar cell module 100 has a plurality of electrically interconnected (in series and/or in parallel) solar cells 102 according to different exemplary embodiments. Each solar cell 102 has a front-side surface 104 and a rear-side surface 106 which is opposite the front-side surface 104 The solar cells 102 are adjacently disposed such that there is a cell gap 108 between two respective mutually adjoining solar cells 102. Furthermore, the solar cell module 100 has an encapsulation 110 (for example of EVA) of the front-side surface and the rear-side surface of the solar cells 102, which substantially completely surrounds the solar cells 102 (however still enables an electrical contacting of the solar cells 102 through the encapsulation 110). A first transparent cover plate 112 is provided over the encapsulation 110, which is affixed, for example on the encapsulation 110, and which covers the front-side surface of the solar cells 102. A second transparent cover plate 114 is provided over the encapsulation 110 on the side of the encapsulation 110 opposite the first transparent cover plate 112, for example similarly affixed thereon, wherein the second transparent cover plate 114 covers the rear-side surface 106 of the solar cells 102. In different exemplary embodiments, the solar cells 102, the encapsulation 110, the first transparent cover plate 112 and the second transparent cover plate 114 form a module laminate 116.

Furthermore, the solar cell module arrangement 100 has a mounting frame 118, which surrounds and thereby holds the solar cell module 100 at the edge thereof by means of one or more clamps 120 (which can be provided with a buffer material, for example soft rubber or an adhesive, in order to prevent damage to the solar cell module 102). In addition, a reflecting plate 122 (for example a metal sheet or a plate coated with a metallic layer, for example a plastic plate) as a diffuser backside reflector 122 can be mounted in the mounting frame 118. It should be noted that additionally the reflecting plate 122 can also have a mechanical stabilizing function. The reflecting plate 122, generally the diffuse backside reflector 122, is disposed outside the module laminate 116 according to these exemplary embodiments. In different exemplary embodiments, the reflecting plate 122 can be curved or corrugated, so that, for example the reflecting plate 122 can be additionally fixed (for example by means a supporting structure 124 (for example by means of an adhesive 124)) for edge fixing by means of the mounting frame 118 under the solar cells 102 on the module laminate 116 for improved stability of the solar cell module 100. In this way, spaces 126 are clearly formed, the heights 128 (i.e. distance from the underside 130 of the module laminate 116 up to the upper side 132 of the reflecting plate 122) of which is in a range of approximately 0.5 cm to 20 cm, for example in a range of approximately 1 cm to 10 cm, for example approximately 3 cm.

Thereby, the reflecting plate 122, generally the diffuse backside reflector 122, can be disposed outside the module laminate 116 of the solar cell module 100. The metal can be a dull metal or a reflecting metal provided with an embossing (which has for example small indentations of the order of a few mm diameter). Furthermore, instead of metal, a plate print coated with a white ceramic or a white plastic structure can also be used. In general, each diffuse reflecting material can be used for the reflecting plate 122 or as coating at least partially (at least laterally under the cell gaps 108)) of the reflecting plate 516 in this connection.

In general, in different exemplary embodiments, a diffuser backside reflector 122 is provided under the rear-side of the solar cell module 100, wherein the diffuse backside reflector 122 is disposed such that at least one portion of the light, which penetrates through at least one cell gap 108 of the plurality of cell gaps 108, is reflected on the rear-side surface of the solar cells 102 (for example diffuse). In different exemplary embodiments, only a single space is formed, however with grid points behind each of the solar cells 102.

FIG. 2 shows a cross-sectional view of a portion of a solar well module arrangement 200 according to different exemplary embodiments.

The solar cell module arrangement 200 according to FIG. 2 is very similar to the solar cell module arrangement 100 according to FIG. 1, which is why only the differences are explained in more details in the following.

The solar cell module arrangement 200 essentially differs from the solar cell module arrangement 100 according to FIG. 1 by a different configuration, fixing and positioning of the diffuse backside reflector.

Even according to these exemplary embodiments, a reflecting plate 202 (for example a metal sheet or a plate coated with a metallic coating or a white film) used as diffuser backside reflector 202 is provided, which is mounted on the mounting frame 118, however not in the clamp 120, but for example at the lower end 204 of the mounting frame 118. The reflecting plate 202, generally the diffuse backside reflector 202 is similarly disposed outside the module laminate 116 according to these exemplary embodiments. In different exemplary embodiments, the reflecting plate 202 can be curved or corrugated or even substantially plane. In different exemplary embodiments, only a single space 206 is thereby formed between the module laminate 116 and the reflecting plate 202. The space 206 has for example a height 208 (i.e. a distance from the underside 130 of the module laminate 116 up to the upper side 210 of the reflecting plate 202) in a range of approximately 0.5 cm to 20 cm, for example in a range of approximately 1 cm to 10 cm, for example approximately 3 cm.

Thus the reflecting plate 202, generally the diffuse backside reflector 202 can be disposed outside the module laminate 116. The metal can be a dull metal. Furthermore, instead of metal, even a plate print coated with a white ceramic or a plastic film can be used. In general, in this connection, each diffuse reflecting material can be used for the reflecting plate 202 or as coating (at least partially (at least laterally under the cell gaps 108)) of the reflecting plate 202.

In general, in different exemplary embodiments, here also a diffuser backside reflector 202 is provided under the rear-side of the module laminate 116, wherein the diffuse backside reflector 202 is disposed such that at least a portion of the light which penetrates through at east one cell gap 108 of the plurality of cell gaps 108, is reflected (for example diffuse) on the rear-side surface of the solar cells 102.

By using a bifacial solar cell in a solar cell module with two transparent cover plates, for example a glass-glass solar cell module, the original disadvantage of the loss of performance by light scattering behind the solar cell can purposely be used advantageously. In order to amplify the light scattering behind the bifacial solar cell, the space behind the solar cells can be dyed white for example in roof integration and the solar cell module can be or can be configured transparent. By a structured rear-side, the incident light can be additionally amplified, since the light is deflected further behind the solar cell. The deeper the cell gap between the solar cells, the more light can be captured by the solar cell module, since the angle of opening of the cone of scattering of light which can still escape, is always smaller. Ideally, almost 100% of the light between the solar cells can be used.

For example, in the exemplary embodiments in which the diffuse backside reflector is attached outside the module laminate, the cell gaps and the distance from the edge of the solar cell module can be greater than in a conventional solar cell module. So for example, the cell gap can be in a range of approximately 3 mm to approximately 50 mm or even thereabout, for example in a range of approximately 10 mm to approximately 50 mm.

The solar cells 102 can be bifacial solar cells 102, for example completely bifacial solar cells 102 or partially bifacial solar cells 102.

In case that the solar cells 102 are partially bifacial solar cells 102, the solar cells 102 can be fitted as the so-called PERC-solar cells (PERC: Passivated Emitter Rear Cell), that is as solar cells 102, the rear-side of which is passivated.

It should be noted that in different exemplary embodiments, the photovoltaic cells are not restricted to PERC cells, but even other completely or partially bifacial photovoltaic cells can also be provided in this manner, in order to save the rear-side metal, for example Silver on the photovoltaic cells.

The solar cell 102 has a substrate 302. The substrate 302 can have or consist of at least on photovoltaic layer. Alternatively, at least one photovoltaic layer is disposed on or above the substrate 302. The photovoltaic layer can have or consist of semiconductor material (such as Silicon) or a composite semiconductor material (such as a composite semiconductor material III-V (such as GaAs). In different exemplary embodiments, Silicon can have or consist of monocrystalline Silicon, polycrystalline Silicon, amorphous Silicon, and/or microcrystalline Silicon. In different exemplary embodiments, the photovoltaic layer can have or consist of a semiconductor transition structure such as a pn-junction structure, a pin-junction structure, a Schottky-like junction structure, and the like. The substrate 302 and/or the photovoltaic layer can be provided with a base doping of a first type of conductor.

In different exemplary embodiments, the base doping in the substrate 302 can have a doping concentration (for example a doping of the first type of conductor, for example a p-doping, for example a doping with Boron (B)) in a range of approximately 10¹³ cm⁻³ to 10¹⁸ cm⁻³, for example in a range of approximately 10¹⁴ cm⁻³ to 10¹⁷ cm⁻³, for example in a range of approximately 10¹⁵ cm⁻³ to 2*10¹⁶ cm⁻³.

The substrate 302 can be made of a solar cell wafer and can have, for example a round shape such as a circular shape, or a polygonal shape such as a square shape. In different exemplary embodiments, however, the solar cells of the solar module can also have non-quadratic shape. In these cases, the solar cells of the solar module can be formed, for example by severing (for example cutting) and thereby dividing one or more (also referred to in their shape as Standard solar cell) solar cell(s) into several non-quadratic or quadratic solar cells. In different exemplary embodiments, it can be provided in these cases, to undertake adaptations of the contact structures in the Standard solar cell, for example the backside cross-structures can additionally be provided.

In different exemplary embodiments, the solar cell 102 can have the following dimensions: the width in a range of approximately 5 cm to approximately 50 cm, the length in a range of approximately 5 cm to approximately 50 cm, and the thickness in a range of approximately 50 μm to approximately 300 μm.

The solar cell 102 can have a front-side (also referred to as Light incident side) 104 and a rear-side 106.

According to different exemplary embodiments, a base area 308 and an emitter area 310 are formed in the photovoltaic layer. The base area 308 is doped, for example, with dopant of a first type of doping (also referred to as first type of conductor), for example with dopant of p-type of doping, for example with dopant of the group of the periodic system, for example with Boron (B). The emitter region 110 is doped, for example, with dopant of a second type of doping (also referred to as second type of conductor), wherein the second type of cloning is opposite the first type of doping, for example with dopant of n-type of doping, for example with dopant of the V^{th} main group of the periodic system, for example with Phosphorous (P).

In different exemplary embodiments, optionally a selective emitter can be formed in the emitter region 310. Furthermore, on the front-side 104 of the solar cell 102, electrically conductive current collection structures (for example a metallization such as a Silver metallization, which can be formed by baking a Silver paste (the Silver paste can be formed from Silver particles, glass frit particles and organic excipients)) such as the so-called contact fingers and/or so-called Bunbars (not represented) can be provided.

In different exemplary embodiments, optionally an anti-reflection layer (for example having or consisting of Silicon nitride) can be applied on the exposed upper surface of the emitter region 310 (not represented).

Furthermore, a plurality of metallic solder pads (not represented) can be provided, wherein each solder pad is electrically connected to the emitter region, for example by means of a current collecting structure.

In different exemplary embodiments, the areas with increased dopant concentration can be doped with a suitable dopant such as Phosphorous. In different exemplary embodiments, the second type of conductor can be a p-type of conductor and the first type of conductor can be an n-type of conductor. Alternatively, in different exemplary embodiments, the second type of conductor can be an n-type of conductor and the first type of conductor can be a p-type of conductor.

For reasons of simple explanation, the individual elements which are provided on the front-side 104 of the solar cell 102; are not represented in the figures.

Furthermore, the solar cell 102 has a dielectric layer structure (also referred to as passivation structure) on the rear-side 106 thereof. The dielectric layer structure 312 has, for example, a double layer of thermal oxide and Silicon nitride. Alternative layer structures are however also possible for the dielectric layer structure 312. For example, a random layer stack with layers having one or more of the compounds, Silicon nitride, Silicon oxide or Aluminum oxide can be provided in the dielectric layer structure 312.

A metallization 314 is provided on the side of the dielectric layer structure 312 opposite the substrate 302, wherein the surface area of the metallization 314 (for example of Aluminum and/or Silver) in the middle area 316 of the substrate 302 is greater than in the edge area 318 of the substrate 302, which surrounds the middle area 316 at least partially that is partially or completely). Thus, in different exemplary embodiments, the metallization 314 has substantially two partial areas, namely:
a substantially full surface first partial area 320, which is disposed substantially in the middle area 316 of the substrate 302 on the dielectric layer structure 312 and is electrically connected to the substrate 302, for example to the base area 308 of the substrates 302 (in this connection, it should be noted that even a metallization can be used in different exemplary embodiments, which is equipped to breach through the Nitride layer (so-called continuous burning metallization paste) by means of contact holes (also referred to as contact openings, for example local contact openings (LCO, local contact openings)) 322, which extend through the dielectric layer structure 312. Thereby, a contact through the dielectric layer structure can be made through even without Laser opening); and
a second partial area 324, which is disposed substantially in the edge area 318 of the substrate 302 on the dielectric layer structure 312;
   the second partial area 324 is formed, for example, of current collecting structures, which are similar to the current collecting structures on the front-side 104 of the substrate 302;
   for example, electrically conducting contact fingers (for example of the same material, for example of the same metal, such as the first partial area 320, for example of Aluminum, or of another material, for example another metal) can be provided in the second partial area 324;
   the shape of the current collecting structures is basically random;
   the current collecting structures are electrically connected at least partially with the first partial area and/or (likewise for example by means of contact holes or contact lines with the substrate 302, for example with the base area 30$ of the substrate 302.

The surface area of the metallization 314 in the middle area 316 of the substrate 302 is greater than in the edge area 318 of the substrate 302, which at least partially surround the middle area 316. Even if, the edge area 318 in FIG. 3A completely surrounds the middle area 316, it can be provided alternatively that the edge area 318 only partially surrounds the middle area 316. The shape and connection of the individual elements of the current collecting structures can be random, for example, contact fingers and/or at least a metal grid and/or metallic honeycombs and/or other openings in the metal surface with random surface cross-sections) can be provided, as described above.

Evidently, the edge area 318 is substantially free from metal (except for the metal of the second partial area 324 of the metallization 314), so that the exposed area of the dielectric layer structure 312 is permeable to light and thus for example, the light penetrating through a cell gap, for example, which is reflected back in any manner (for example diffuse) in the direction towards the rear-side 104 of the substrate 302, can reach back into the base area 308 of the substrate 302 and can form excitors there, whereby an additional contribution is made for producing electrical energy.

Therefore, the efficiency of the solar cell 102 is significantly increased as compared to a pure front-side solar cell. Evidently, the solar cell 102 thus represents a part-bifacial (in other words partially bifacial) solar cell 102. The part-bifacial solar cell 102 furthermore has the advantage of an additionally reduced series resistance as compared to a 100% bifacial solar cell, which can however be similarly used in different exemplary embodiments.

The edge area 318 can have a width in a range of approximately 0.5 cm to approximately 5 cm, for example a width in a range of approximately 1 cm to approximately 3 cm.

The middle area 316, which is substantially fully covered with a metal, for example Aluminum, has an area in a range of approximately 213 cm² to approximately 31 cm², for example in a range of approximately 185 cm² to approximately 92 cm².

Furthermore, a plurality of metallic solder pads 326 can be provided, wherein each metallic solder pad 326 is electrically connected to the metallization 314. The several metallic solder pads 326 can optionally break through the layer structure 312.

In different exemplary embodiments, the surface area of the metallization 314 increases from the edge area 318 towards the middle area 316, for example continuously or in multiple levels.

FIG. 4 shows an enlarged section 400 of a rear slue view of a corner of a solar cell according to different exemplary embodiments. The solar cell can have a similar or identical construction as the solar cell 102 represented in FIG. 3A and FIG. 3B, however, wherein the rear-side current collecting structure 402 has a different shape in the edge area 318 (i.e. the second partial area of the metallization) in the solar cell represented in FIG. 4 than the current collecting structure in the edge area 318 in FIG. 3B. So, the rear-side current collecting structure 402 in FIG. 4 is formed of exclusively straight linear contact fingers 402 in this exemplary embodiment (even non-straight contact fingers 402 can be provided in different exemplary embodiments), which are electrically connected to the complete metallayer 320 in the middle area of the solar cell 400, wherein the contact fingers 402 extend substantially perpendicular to a respective edge of the solar cell, however, do not extend up to the respective edge. In the corners 404 themselves, a contact finger 406 each is provided as part of the current collecting structure, which extends from the corresponding corner 408 of the first partial area 320 in straight line towards the corner 404 of the solar cell 400, however does not contacts this. In the current collecting structures 324 according to FIG. 3A, angular contact fingers 324 are also provided with several partial areas, which can be disposed at an angle with respect to each other.

Therefore, the edge area 318 of the solar cell 102 clearly represents a bifacial edge area, which is equipped for receiving the light, which can reach into the base area 308 of the solar cell 102 in order to be used for power generation there.

Even if the solar cell 102 is a PERC-solar cell, the embodiments are however not limited to such a PERC-solar cell. The described part-bifacial solar cell can be any random type of a solar cell, only with respective correspondingly adapted backside metallization.

If for example, the rear-side of the substrate of a solar cell is not completely passivated, as in a PERC solar cell, then additionally in the edge area in which the rear-side of the base area is partially exposed, this can be additionally covered with a passivation layer and the second partial area of the current collecting structure can then be disposed on the passivation layer. The passivation layer can have or be Silicon nitride. The passivation layer can have one or more dielectric layers. FIG. 5 shots an exploded representation of a solar cell module 500 according to different exemplary embodiments.

As shown in FIG. 5, the solar cell module 500 has a module laminate 502, which is framed by a module frame 504 and is held thereby. The module frame 504 laterally surrounds the module laminate 502 partially or completely and surrounds the side walls of the module laminate 502. Furthermore, module rear-wall 506 is provided, which is fixed on the module frame, for example screwed on or affixed, or riveted or attached in any other suitable manner. Even if for reasons of clarity, the solar cells are not represented in FIG. 5, then it should be noted that the rear-side cover plate is transparent and thus complete or partially bifacial solar cells would actually be seen on the rear-side.

The module laminate 502 has, as was described above, several electrically interconnected photovoltaic cells, for example solar cells which are embedded in an encapsulation material. The several solar cells are adjacently disposed such that there is a cell gap between two respective mutually adjoining solar cells. The module laminate 502 has a front-side surface and a rear-side surface 508 which is opposite the front-side surface.

The module rear-wall 506 is disposed at a distance from the rear-side surface 508 of the module laminate 502 and covers at least a portion of the rear-side surface 508 of the module laminate 502. The module rear-wall 505 can be formed of one or more plates, for example metal plates and/or plastic plates. The module rear-wail 506 can have several differently formed areas, so that for example, a stepped (or for example even wave shaped) structure. So, the module rear-wall 506 has, for example a first area 510, a second area 512, and a third area 514. In different exemplary embodiments, even fewer or more areas can be provided in the module rear-wall 506. A first portion of the formed plate 506 in the first area 510 is higher than a second portion of the formed plate 506 in the second area 512 which is immediately adjacent the first area 510. This means that the first portion of the plate 506 in the first area 510 with completed assembly on the module frame 504 is further away from the rear-side surface 508 of the module laminate 502 than the second portion of the plate 506 in the second area 512. Furthermore, the second portion of the formed plate 505 in the second area 512 is lower than a third portion of the formed plate 506 in the third area 514 which is immediately adjacent the second area 512. This means that the third portion of the plate 506 in the third area 514 with completed assembly on the module frame 504 is similarly further away from the rear-side surface 508 of the module laminate 502 than the second portion of the plate 506 in the second area 512. Therefore, a space with different heights (seen emanating from the rear-side surface 508 of the module laminate 502 towards the respective surface of the module rear-wall 506 facing the space, is formed between the assembled module rear-wall 505 and the rear-side surface 508 of the module laminate 502.

Furthermore,an electrical junction box 516 is provided, from which the electrical energy provided in the form of an electrical voltage and an electric current from the photovoltaic module 500, is provided by means of an interface. The electrical junction box 516 is attached, for example on the rear-side surface 508 of the module laminate 502, for example of on the module laminate 502. The spatial placement of the electrical junction box 516 is basically random, however in this exemplary case, under the part of the module rear-wall 506 in the second area 512. The electrical junction box 516 can alternatively or additionally be held by means of the module rear-wall 506 on the rear-side surface 508 of the module laminate 502, for example clamped.

Further, the photovoltaic module 500 can have one or more electronic components 518, which can be similarly attached on the rear-side surface 508 of the module laminate 502. Thus, evidently the at least one electronic component can be disposed between the rear-side surface 508 of the module laminate 502 and the module rear-wall 506. The at least one electronic component 518 can have a DC converter and/or a module inverter or can be fitted in the same manner. The at least one electronic component 518 can alternatively or additionally have so-called bypass diodes. There can also be several bypass diodes installed in parallel in order to better and uniformly distribute the converted heat without overheating in case of bypass, the bypass diodes can also be attached on the rear-side cover plate (for example if this is made of metal) thermally conducting in order to ensure heat dissipation.

The electrical junction box 516 in this case contains, for example no more diodes and can be configured, for example only as a pure contact structure (connector) for photovoltaic cell matrix.

The spatial placement of the at least one electronic component 518 is basically random, however in this exemplary case, under the part of the module rear-wall 506 in the first area 510. The at least one electronic component 518 can be held on the rear-side surface 508 of the module laminate 502 by means of the module rear-wall 506, for example clamped. In other words, the module rear-wall 506 can hold the at least one electronic component 518 on the rear-side sur face 508 of the module laminate 502.

Furthermore, an inverter circuit (not represented) can be provided in the photovoltaic module 500, which can be integrated in the electrical junction box 516 or can be provided externally from this. Accordingly, in the inverter circuit, which have circuit components required for a DC/AC conversion, for example a corresponding interconnection of diodes, transistors, coils and capacitors. For increasing the albedo, it can be further provided that the surface of the inverter circuit facing the module laminate 502 has a high albedo, for example, is white.

Furthermore, a cover plate 520 can be provided, which partially or completely covers the space formed between the module rear-wall 506 and the rear-side surface 508 of the module laminate 502. So, it can be provided that the cover plate 520 covers the first portion of the module rear-wall 506 in the first area 510, however not the other areas 512, 514. This is symbolically represented in FIG. 5. The cover plate can also have a cable duct 522, through which, for example, a cable 524 is guided from outside the space for electrical connection of the at least one electronic component 518.

FIG. 6A shows a rear-side and FIG. 6B shows a sectional view of the assembled solar well module 500 from FIG. 5, however wherein the module rear-wall 506 in this case has a plane and not stepped shape.

In this represented example, the at least one electronic component 518 is a micro-inverter circuit, which is electrically connected to the electronic junction box 516 by means of two power cables 602, 604, so that an alternating voltage/current is supplied to the electrical junction box from the micro-inverter circuit by means of both the power cables 602, 604. The at least one electronic component 518 can be pressed, as explained above, by the module rear-wall 506 on the rear-side surface 508 of the module laminate 502 and can be held in this way, or it can be fixed alternatively or additionally on the rear-side surface 508 of the module laminate 502 in another manner, for example by means of a separate clamping system of a separate clamping arrangement, an adhesive, or by means of another fixing means, for example by means of screws, rivets, etc.

It should be noted that in this represented example, the module rear-wall 506 does not cover the entire rear-side surface 508 of the module laminate 502. A non-covered partial area 606 of the rear-side surface 508 remains exposed.

Such a photovoltaic module 500 offers various advantages, for example:
it offers a compact construction and thus a positive “Look and Feel” sense for the user;
lower installation costs;
a high level of (electrical) safety;
a secure cable length; and
the option to provide a standardized fixing of the individual components.

FIG. 7A shows a rear-side view and FIG. 7B shows a sectional view of an assembled solar cell module 700 according to different exemplary embodiments.

The solar cell module 700, which is represented in FIG. 7A is very similar to the solar cell module 500 from FIG. 6A, however wherein in this exemplary case, the module rear-wall 506 covers the entire rear-side surface 508 of the module laminate 502.

The other components correspond to those of the solar cell module 500 from FIG. 6A, which is why a reference is made to the above explanations for describing the same.

In addition to the advantages which are already achieved by the solar cell module 500 from FIG. 6A, the solar cell module 700 according to FIG. 7A offers an additionally improved efficiency, since in the design of the side of the module rear-wall 506 facing the rear-side surface of the module laminate, as a highly reflecting surface, and thus as a surface with a high albedo, still more light which penetrates through the cell gaps, is again reflected back on the bifacial solar cells of the solar cell module 700.

The module rear-wall 506 can have at least one through opening in all exemplary embodiments.

So, the module rear-wall 506 can have at least one first area which extends substantially parallel to the rear-side surface 508 of the module laminate 502 and has at least one second area which does not extend parallel to the rear-side surface 508 of the module laminate 502. The module rear-wail 506 can have at least one through opening in the at least one second area.

The at least one through opening can be dimensioned and disposed in the module rear-wall 506 such that an air-circulation is enabled by means of convection.

Furthermore, additional designs can be provided in different exemplary embodiments. So, for example, a blower, for example designed as a cross-blower, can be provided in the space between the module rear-wall 506 and the rear-side surface 508 of the module laminate 502. The blower is fitted for producing a forced air-circulation, wherein the heated air can optionally be supplied to a heat pump.

Furthermore, additionally or alternatively at least one through opening can also be provided on each side in the module frame 504, so that an air-circulation is enabled through this.

In general, the module rear-wall 506 can be in thermally conducting contact with the at least one electronic component 518.

In different exemplary embodiments, the diffuse rear-side reflector, that is for example, the “inner side” of the module rear-wall 506 can be disposed at a distance of several cm, for example in the range of approximately 1 cm to approximately 10 cm from the rear-side surface 508 of the module laminate 502.

Generally, the efficiency of the solar cell and/or the inverter circuit can be increased in the photovoltaic module by improving the air-circulation and the service-life of electronic components can be increased.

Furthermore, the cable/s can be disposed at an angle 45°. In this way, cable material could be saved.

Furthermore, for example, both the power cables 602, 604 can be cables which are surrounded by a rubber jacket as protective jacket.

Furthermore, it can be provided in different exemplary embodiments that the diffuse backside reflector is formed from a plurality of layers stacked on top of each other. Evidently, this corresponds to a multi-layer reflector construction for increasing the power output from a photovoltaic module with partially or completely bifacial photovoltaic cells. Evidently, the diffuse scattering of the light penetrating through the cell gaps can be increased by a suitably selected layer stack.

So in general, for example, a first layer of several layers of a layer stack facing the module laminate can be transparent and a second layer of the several layers which is disposed on the side of the first layer turned away from the module laminate can have an albedo of at least 50%, for example at least 60% for example at least 70%, for example at least 80%, for example at least 90%. So, for example, the second layer can be white ora micro-structured (diffuse scattering) metal film/or a micro-structured (diffuse scattering) sheet etc. or consist of the same.

In other words, the light scattering surface of the subsurface is coated with a layer of high refractive index, for example with a layer of a refractive index of at least 1.3, for example at least 1.5 in different exemplary embodiments.

The refractive index transition for transparent coating over the light scattering layer, therefore, expands the light scattering cone depending on the refractive index and thereby increases the ratio of the light which is scattered behind the solar cell. The highly refractive coating can either be configured organically or inorganically. For example, a substantially plane glass plate inside the module can be inserted with a diffuse scattering wave structure metal coated outside the module or an outer white coated glass plate with substantially plane parallel surface.

In general, it can be provided to apply a highly refracting, transparent layer on a light scattering layer located behind (partial or complete) bifacial photovoltaic cells for increasing the light scattered on the rear-side of a bifacial photovoltaic module in different exemplary embodiments.

Further, rough, diffuse scattering coatings can be protected from the contamination or diffuse scattering metal surfaces from corrosion and abrasion, by means of a second layer of a multilayer layer-stack.

Different embodiments for a multilayer layer-stack, i.e. a multi-layer reflector construction are described in more detail in the following.

In general: The flatter the light is scattered, the more light reaches the rear-side of the solar cell. However, the scattering angles of ideal Lambertian reflectors are naturally determined and a significant portion of the light is again scattered from the cell gaps out of the module. In order to reduce these losses, the solar cells are installed at greater distance over the back-reflector whereby the opening angle of the scattering cone reduces and the losses are reduced. This solution is expensive, because the distance of laminate and back-reflector must be increased, whereby the module frame must be widened.

In different exemplary embodiments, the light scattering characteristics of the back-reflector are deliberately influenced in order to flatten the scattering cone of the light and to guide more light behind the photovoltaic cells.

For quantitative description of the light reflected and captured by light scattering, it is assumed that all light is scattered back from the rear-side and completely diffused independent of the wavelengths—thus Lambert's Law applies.

FIG. 8 shows a representation 800 for explaining Snell's Law, wherein an incident light beam 802 penetrates through a transparent coating 804 (which has a refractive index n₂) and is scattered back diffuse on a light scattering layer 806 at a first angle α in the direction of the transparent coating 804. On the interface between the transparent coating 804 and air 808 (which has a first refractive index n₁), the scattered light beam 810 escapes at a second angle β from the transparent coating 804 (escaping light beam 812) or is totally reflected back into the transparent coating 804 (totally reflected light beam 814). The so-called critical angle δ for the total reflection results in: δ=n₂/n₁.

The distribution of the light escaping from the multi-layered construction is highly shifted to larger angles deviating from the normal to the layers. If a corresponding layer structure as back-reflector is applied on the ground of a solar field with bifacial photovoltaic modules or as rear-side module rear-wall of a photovoltaic module, as it was described above, more light strikes on the module rear-side independent of the direction of the incident light (altitude of the Sun) (see Diagram 900 in FIG. 9, which represents a first intensity distribution 902 for a diffuse reflector and a second intensity distribution 904 for a diffuse reflector with beam expansion).

In different exemplary embodiments, such a layer-stack can have (for example a layer-stack 1000, as represented in FIG. 10) at least two layers or can consist of at least two layers, for example a light scattering layer 1006 and a transparent coating with almost plane surface 1002. Ideally, both layers 1002, 1006 have the same or similar material composition, only the lower light scattering layer 1006 can still be filled with additional light scattering bodies. The basic material (also referred to as matrix material) of the light scattering layer 1006 should offer an excellent connection to the light scattering bodies. Ideally, light of a wavelength of approximately 400 nm to approximately 1200 nm is almost completely reflected. The transparent top layer 1002 should form a surface as smooth as possible, have a high refractive index, be constructed easy to clean or less contaminating and light stable.

The segregation of light scattering characteristics and surface characteristics is additionally advantageous, because ideally a monolithic layer can mostly just partially satisfy all the requirements.

Reflectors can be made of different polymer layers, which fulfil the different tasks (UV protection, weather resistance) and e.g. a layer for increasing the mechanical stability e.g. with inserted glass fibres. By the transparent top layer 1002, in addition, the risk of contamination of the light scattering bodies is lower, or the cleaning is simplified, because there are no inorganic particles on the surface. For example, highly refracting materials such as Titanium oxide, Calcium carbonate but also for example, polymer hollow spheres, or foamed polymer layers, but also roughened metallic layers or metal powders are provided as light scattering bodies 1006 in different exemplary embodiments. The most polymers have very similar refractive indices in the range of 1.5. Therefore, even combinations of different polymers are provided in different exemplary embodiments, for example, because certain polymers which tend to crystallize are also light scattering without fillers. So for example, polyethylene with a layer of a transparent polymer could be provided.

Even in such an exemplary embodiment, a doubled layer construction would be selected. For example, a white, base material (which clearly corresponds to the light scattering layer 1002) with a transparent enamel (which clearly corresponds to the transparent layer 1004) can be provided, or a double layered enamel can be inserted. In different exemplary embodiments, a structured sheet (with only very small structures of, for example, smaller or equal to 1 mm with transparent enamel) can be provided. Inorganic enamels additionally have the advantage that here even materials with higher refractive indices and correspondingly greater light capture are available.

The layer-stack can also have more than two layers, for example three, four, five, six or even more layers stacked disposed one on top of another.

Ideally, the refractive index of the medium, by which the respective scattering body is covered, should be as high as possible. Common polymers have only medium refractive indices in a range of approximately 1.5—a corresponding increase would be possible, however costly.

However, for multilayer constructions with different refractive indices, it can be shown that only the difference of the refractive indices between light scattering layer and air is relevant. The layers with her refractive index found above this do not change the scattering angle of the light emitted. This enables the use of expensive materials matching in the refractive index, because these must be applied only in few μm thick layers on the supporting polymers.

Three basic structures are provided in different exemplary embodiments.
1. Apply another layer of lower refractive index (about 1.3) on the transparent layer of a common polymer; this reduces the reflection of light during entry into the multilayer construction and also during exit again. For example, one such construction can consist of a thick mechanically resilient transparent layer with medium refractive index. This is coated white on the underside and covered on the upper side with a lowly refracting polymer. In this case, e.g. ETFE or used polymers—which are additionally very weather and UV stable and do not contaminate, can be inserted.
2. Further, a supporting layer of medium refractive index can be provided, under which a thin highly refracting layer is diposed, under which, there is only the light scattering medium. This would flatten the escape angle of the light even further.
3. The combination of 1. and 2. Seen from below (in other words, seen during assembly of the photovoltaic modules from the ground): Light scattering layer, highly refracting layer, supporting layer of medium refractive index (Standard polymer), lowly refracting final layer.

1. Photovoltaic module comprising:
a module laminate with several electrically interconnected partially or completely bifacial photovoltaic cells, which are embedded in an encapsulation material, wherein the photovoltaic cells are adjacently disposed such that there is a cell gap between two respective mutually adjoining photovoltaic cells, wherein the module laminate includes a front-side surface and a rear-side surface which is opposite the front-side surface;
a module frame, which encircles the module laminate;
a module rear-wail disposed at a distance from the rear-side surface of the module laminate and fixed on the module frame, which covers at least one portion of the rear-side surface of the module laminate;
wherein at least one portion of the module rear-wall which is facing the rear-side surface of the module laminate, forms a diffuse backside reflector;
wherein the diffuse backside reflector is disposed such that at least one portion of the light which penetrates through at least one cell gap of the several cell gaps, is reflected on the rear-side surface of the module laminate.

2. Photovoltaic module according to claim 1, wherein the module rear-wall completely covers the rear-side surface of the module laminate.

3. Photovoltaic module according to claim 1, wherein the module rear-wall is spaced apart from the module frame and is fixed to the module frame by means of spacers.

4. Photovoltaic module according to claim 1, wherein the diffuse backside reflector has an albedo of at least 50%, preferably at least 80%.

5. Photovoltaic module according to claim 1, wherein the surface of the diffuse backside reflector facing the module laminate has several layers.

6. Photovoltaic module according to claim 1,
wherein an upper layer of the several layers facing the module laminate is transparent; and
wherein a lower layer of the several layers has an albedo of at least 50%, preferably at least 80%.

7. Photovoltaic module according to claim 1, wherein the lower layer is white or includes a micro-structured metal film or a micro-structured sheet or consists of the same.

8. Photovoltaic module according to claim 1, wherein at least one portion of the inner side of the module frame has an albedo of at least 50%, preferably at least 80%.

9. Photovoltaic module according to claim 1, wherein the module rear-wall includes at least one plastic plate or film.

10. Photovoltaic module comprising
a module laminate it with several electrically interconnected photovoltaic cells, which are embedded in an encapsulation material, wherein the several photovoltaic cells are adjacently disposed such that there is a cell gap between two respective mutually adjoining photovoltaic cells, wherein the module laminate includes a front side surface and a rear-side surface which is opposite the front-side surface;
a module frame which encircles the module laminate;
a module rear-wall disposed at a distance from the rear-side surface of the module laminate and fixed on the module frame, which covers at least one portion of the rear-side surface of the module laminate;
at one electronic component which is disposed between the rear-side surface of the module laminate and the module rear-wall;
wherein the module rear-wall holds at least one electronic component.

11. Photovoltaic module according to claim 10, wherein the at least one electronic component comprises one DC converter or a module inverter and/or one or more bypass diodes.

12. Photovoltaic module according to claim 10, wherein the module rear-wall comprises at least one metal plate and wherein the module rear-wall makes an electrically conductive connection between the electrical component and the module frame.

13. Photovoltaic module according to claim 10, wherein the module rear-wall comprises at least on through opening.

14. Photovoltaic module according to claim 10,
wherein the module rear-wall comprises at least one first area, which extends substantially parallel to the rear-side surface of the module laminate and includes at least one second area, which does not extend parallel to the rear-side surface of the module laminate; and
wherein the module rear-wall includes includes at least one through opening in the at least one second area.

15. Photovoltaic module according to claim 10, wherein the at least two through openings are dimensioned and disposed in the module rear-wall such that an air-circulation is enabled.

16. Photovoltaic module according to claim 10 further comprising: at least one blower, which s disposed between the rear-side surface of the module laminate and the module rear-wall, for producing a forced air-circulation.

17. Photovoltaic module according to claim 1 wherein least one through opening is provided in the module frame on each side, so that an air-circulation is enabled therethrough.

18. Photovoltaic module according to claim 10, wherein the module rear-wall is in thermally conducting contact with the at least one electronic component.

19. Photovoltaic module according to claim 1, wherein the diffuse backside reflector is disposed at a distance of several cm, preferably in a range of approximately 1 cm to approximately 10 cm from the rear-side surface the module laminate.

20. Photovoltaic module according to claim 1, wherein the gap width of at least one cell gap of the several cell gaps is in a range of approximately 3 mm to approximately 50 mm.
